(19) United States
(12) Patent Application Publication
(10) Pub. No.: US 2012/0293813 A1
(43) Pub. Date: Nov. 22, 2012

(54) Methods For Monitoring Growth Of Semiconductor Layers

(75) Inventors: Eric M. Rehder, Los Angeles, CA (US); Matthew Youngers, Norton, MA (US); Peter Rice, South Easton, MA (US)

(73) Assignee: Kopin Corporation, Taunton, MA (US)

(21) Appl. No.: 13/300,128

(22) Filed: Nov. 18, 2011

Related U.S. Application Data
(60) Provisional application No. 61/416,063, filed on Nov. 22, 2010.

(51) Int. Cl. G01B 11/06

(52) U.S. Cl. 356/630

(57) ABSTRACT

Deposition of a thin film is monitored by illuminating the thin film with an incident beam during deposition of the thin film, wherein at least a portion of the incident beam reflects off the thin film to yield a reflected beam; measuring intensity of the reflected beam from the thin film during growth of the thin film to obtain reflectance; and curve-fitting at least part of an oscillation represented by the reflectance data to obtain information about at least one of thickness, growth rate, composition, and doping of the thin film.

### RELATED APPLICATION

This application claims the benefit of U.S. Provisional Application No. 61/416,063, filed on Nov. 22, 2010. The entire teachings of the above application are incorporated herein by reference.

### BACKGROUND OF THE INVENTION

The fabrication of most compound semiconductor devices begins with growth of semiconductor thin films, also known as epilayers, onto a substrate using deposition techniques such as metalorganic chemical vapor deposition (MOCVD) or molecular beam epitaxy (MBE). For both techniques, precise control of the temperature, thickness, growth rate, composition, and doping concentration during film growth is critical. It is desirable to measure these parameters in-situ (during the growth process) to provide information on epilayer properties during growth. These in-situ data may be used to simultaneously provide intra-wafer and inter-wafer uniformity information for each wafer, for example, in a multi-wafer MOCVD reactor. Furthermore, during the epitaxial growth process it is common for many layers to be sequentially deposited on the starting substrate. Once these layers are complete, most metrology techniques only enable analysis of the full structure (i.e., analysis is generally confused by the presence of many similar layers that cannot be clearly or individually identified). Thus, without in-situ monitoring, information about each layer of a complex multilayer structure can be lost. By employing in-situ monitoring, it is possible to simultaneously detect shifts in the properties of the epilayers and minimize time waiting for data collection after film growth. This real-time feedback can allow corrective actions to be taken before additional failed wafers are grown.

Optical techniques can be used for such in-situ measurements by monitoring the thermal irradiance and reflectivity of thin film structures during growth. Emissivity-corrected pyrometry measurements enable accurate determination of the substrate temperature from thermal irradiance through the Stefan-Boltzmann law. Reflectivity data are collected by directing a light source of known wavelength and intensity onto a substrate, then monitoring the intensity of reflected light returned during epilayer growth. The phase shift of the reflected light, caused by differences in refractive index of epilayers in the structure, results in sinusoidal interference patterns known as Fabry-Perot oscillations. The period of the sine wave provides information regarding growth rate, the amplitude is related to the refractive index change from underlying layers, and the damping can be caused by absorption of the growing film.

Unfortunately, present optical techniques for in-situ measurements are not well-suited for measuring extremely thin (e.g., <100 nm) epilayers because thin epilayers may not produce one or more full periods of a sinusoidal interference pattern. As a result, it can be difficult to discern the actual thickness of the deposited layer.

In addition, it can also be difficult to accurately characterize devices that include multiple thin layers, such as Bipolar-High Electron Mobility Transistors (BiHEMTs), which is a semiconductor device with epilayer structure that includes a heterojunction bipolar transistor (HBT) grown on top of a high electron mobility transistor (HEMT) structure. It should be noted that in certain cases the sequence of these layers may be reversed and it may be advantageous to grow the HEMT above the HBT. Such devices are also sometimes known as a Bipolar-Field Effect Transistor (BiFET). The term BiHEMT is used herein to describe any epilayer structure that incorporates the functionality of a bipolar transistor and field-effect transistor. In either case, by combining the advantages of HBTs and HEMTs in the same monolithic structure, BiHEMT can address the demands for greater circuit functionality from a single chip (i.e., increased integration). The BiHEMT circuits are attractive for many applications such as wireless handsets and wireless local area networks. As an example, power amplifier circuits and switches can be integrated in a single BiHEMT chip instead of having a separate power amplifier circuit in an HBT structure and a separate switch circuit in a HEMT structure.

The combined epilayer structures of a BiHEMT are extremely challenging to produce and can include thirty or more discrete layers, each with strict tolerances for film thickness, composition, doping density, and uniformity across the substrate. For these reasons, there is a need for methods controlling the growth of BiHEMT structures. However, monitoring BiHEMT growth by in-situ techniques is complicated by the fact critical epilayers in this structure can be very thin (e.g., less than 100 nm thick). As such, there is also a need for methods to extract information from the in-situ data in a manner that enables analysis of thin film properties during growth.

### SUMMARY OF THE INVENTION

A method of monitoring deposition of thin films onto a substrate includes the steps of :in-situ monitoring to generate reflectance oscillation data during growth of a thin film; curve fitting the reflectance oscillation data to thereby extract information on the thickness, growth rate, composition, or doping of the thin film; and monitoring the thin film, which comprises at least a portion of a BiHEMT structure.

In another embodiment, the method calibrates thickness uniformity, and includes the steps of: in-situ monitoring to generate reflectance oscillation data during growth of a thin film; curve fitting the reflectance data to thereby extract information on the thickness, growth rate, composition, or doping of the thin film; and calibrating for thicknesses of multiple layers of a device structure that includes the thin film.

Compared to other in-situ monitoring techniques, the present in-situ monitoring techniques provide thickness information on thiner layers. For example, the present techniques can derive thickness information from reflectance curves that include only a fraction of an oscillation of an interference pattern. As the complexity of epilayer structures increases, the benefits of in-situ monitoring increase accordingly. In addition, the present techniques make it possible to extract information from the in-situ data in a manner that enables analysis of thin film properties during growth,

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a plot of reflectance versus time with an oscillation of less than one period, which is typical for certain layers of interest for BiHEMT and related structures.

FIG. 2 illustrates a technique for fitting a reflectance curve that represents a very thin epilayer (i.e., an epilayer whose reflectance curve is less than half an oscillation).

FIG. 3 illustrates a technique for fitting a reflectance curve that represents a thin epilayer that is slightly thicker than the epilayer of FIG. 2 (i.e., an epilayer whose reflectance curve includes a reflectance minimum or maximum).

FIG. 4 illustrates a reflectance range of >1 period with both a maximum and a minimum. Such layers typically enable complete fitting of growth rate, film composition, and doping density by methods of this invention.

FIG. 5 is a layer structure of a typical GaAs-based BiHEMT structure

FIG. 6 is a plot of in-situ monitoring data for layers with low, medium, and high doping densities, and illustrates the corresponding differences in reflectance near the reflectance minimum.

FIG. 7 is a plot of reflectance curves from the same material layer collected with different wavelengths of incident light, highlighting the difference in information available as a function of wavelength.

### DETAILED DESCRIPTION OF THE INVENTION

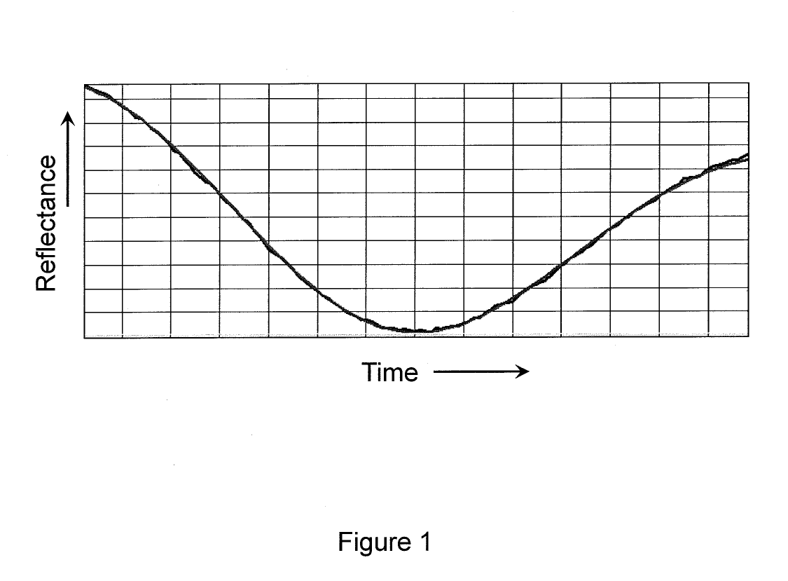

A description of example embodiments of the invention follows. Embodiments of the present invention relate in general to monitoring deposition of thin films, and in particular to in-situ monitoring during the growth of BiHEMT and similar semiconductor device structures. These embodiments provide methods for applying in-situ monitoring to the growth of BiHEMTs and extracting information about the properties of the deposited thin films from their in-situ reflectance curves. Such curves may only contain a portion of an oscillation, as shown in FIG. 1.

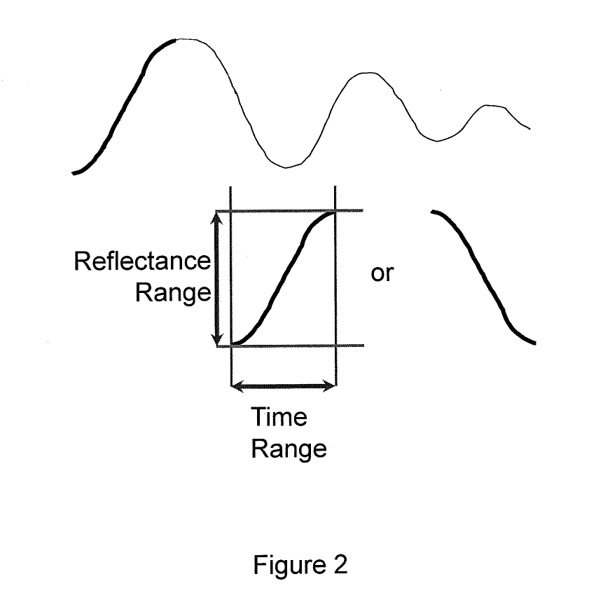

FIG. 2 illustrates techniques for fitting very thin layers of less than half an oscillation. The output includes the change in reflectance from start to end of the layer and the slope. Methods of this invention enable extraction of information regarding film thickness changes of such a layer, enabling more precise control than without such methods.

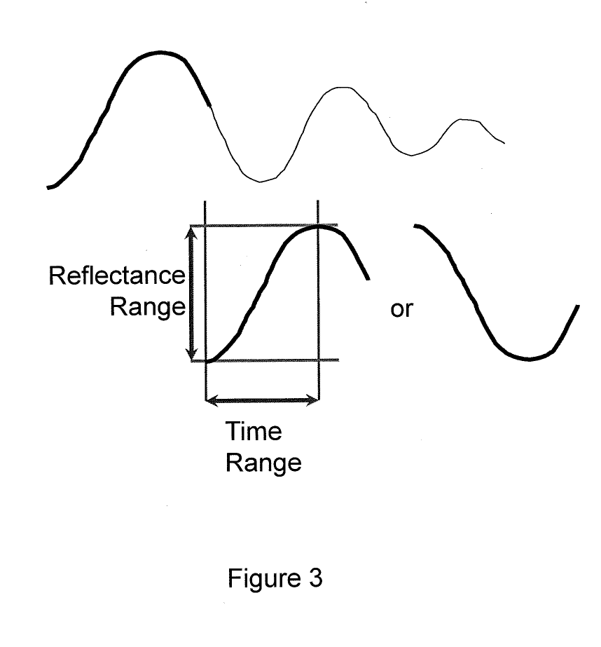

For slightly thicker layers, FIG. 3 illustrates methods of this invention applied to a layer with optical thickness slightly larger than the film of FIG. 2, thus enabling capture of one reflectance minimum or maximum and extraction of information concerning epilayer composition change, including doping density.

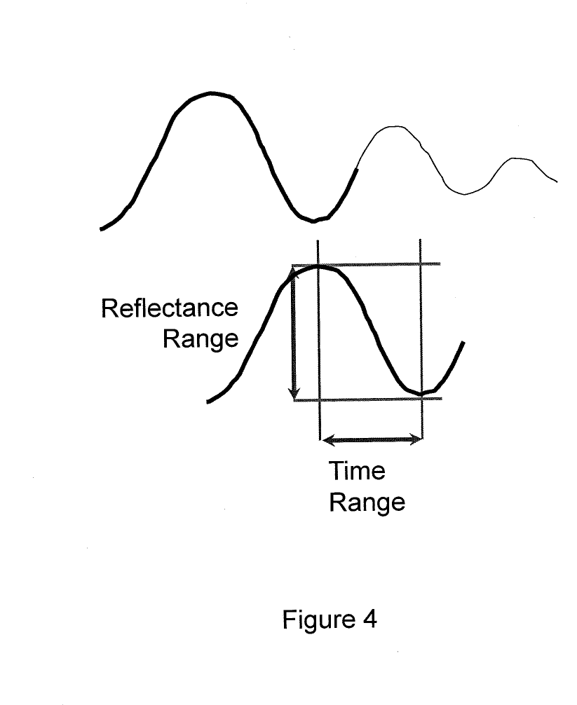

FIG. 4 illustrates methods of this invention applied to a layer that has both a reflectance a maximum and a minimum. The output includes the change in reflectance between the extrema (oscillation amplitude) and the change in time from start to the extrema (oscillation period). Such layers typically enable complete fitting of growth rate, film composition, and doping density. It should be noted that even if absolute magnitudes of each of these parameters is not known with precision, in-situ monitoring techniques as provided by methods of this invention enable discernment of very slight differences between position on a wafer (i.e., intra-wafer uniformity) or between multiple wafers being grown simultaneously (i.e., inter-wafer uniformity). The significant advantages associated with such measurement capability will be evident to those of skill in the art.

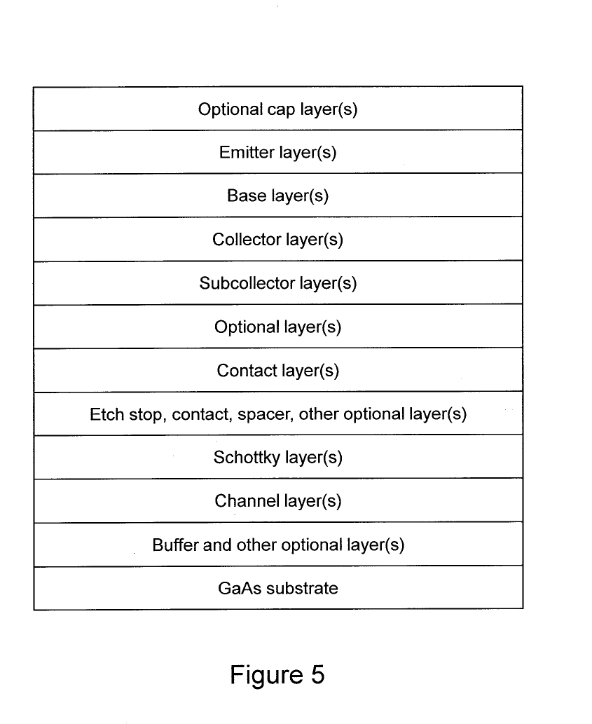

A typical GaAs-based BiHEMT structure is shown in FIG. 5. For such a structure, many of the constituent layers are very thin. Whereas techniques such as photoluminescence (PL) and x-ray diffraction (XRD) can be used to monitor growth of less complex device structures such as GaAs-based, these techniques may not be possible at all for BiHEMTs. Since the HEMT device layers of a BiHEMT are often located below the HBT layers, PL of HEMT layers is not possible due to contributions from overlying layers. Additionally, XRD will be greatly complicated for the same reasons. With in-situ techniques, the buried HEMT layers will also not be affected by measurements of the HBT layers grown above them. More specifically, methods of this invention can provide information regarding the channel layer (often InGaAs), spacer layer (often AlGaAs), and Schottky layer (often AlGaAs). These layers are mentioned as representative examples. Those skilled in the art will appreciate that embodiments of the present invention include other layers not mentioned explicitly in this description.

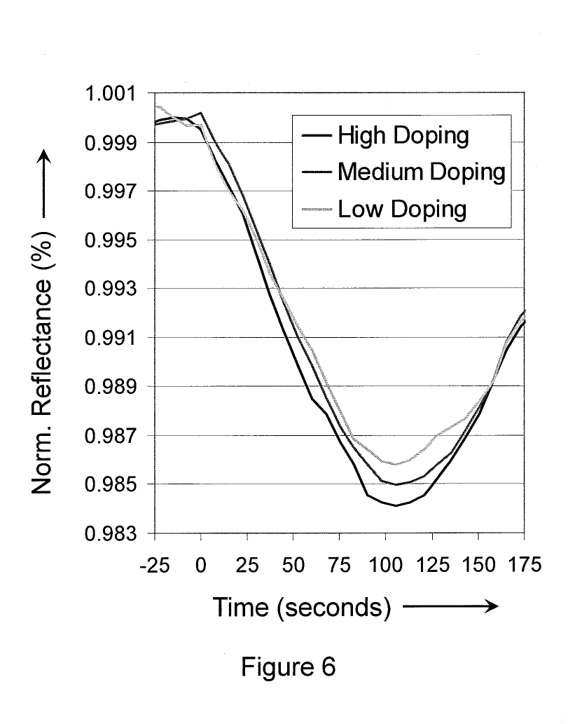

Example data from application of in-situ methods to thin layer with differing doping densities is shown in FIG. 6. Such layers are common, for example, as the base layers of BiHEMT structures (see FIG. 5). Although only a partial oscillation is present, note that the minima of the 3 curves correspond to differing reflectance values and can be used to differentiate between films with high, medium, or low doping density. Such changes can lead to significant shifts in the parametric performance of BiHEMT devices. Specifically, even minor changes in the doping of the base layer of BiHEMT devices can lead to changes in the transistor gain.

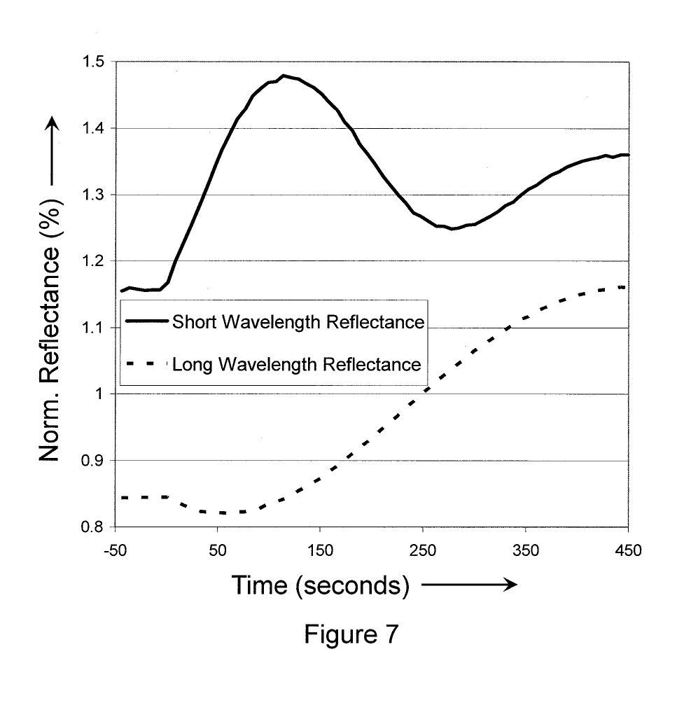

FIG. 7 illustrates how different wavelengths of incident light can lead to differences in in-situ reflectance. The two curves of FIG. 7 were collected from the FET channel of a BiHEMT structure. The short wavelength reflectance trace includes both a minimum and a maximum, whereas the long wavelength reflectance trace contains a minimum and a more gradually increasing slope, but no obvious maximum. The short wavelength data can provide more measurement resolution due to the larger fraction of a period used by the curve fitting algorithms.

For example, the wavelength of the incident light can be used to tailor the in-situ monitoring scheme to the material properties and/or thickness of epilayers of interest. A wavelength of about 950 nm is often used due to the low blackbody incandescence intensity at this energy, which enables the wavelength to be used for both reflectivity and pyrometry measurements. For thin layers or materials with low refractive index, it may be advantageous to use light of shorter wavelength. A wavelength of 633 nm is sometimes used due to the readily available helium-neon laser emitting at this wavelength. However, even shorter wavelength can produce an increased number of oscillations for a given film thickness, thus increasing signal-to-noise of the extracted in-situ data and improving ability to perform curve fitting. Specifically, a wavelength of <600 nm (corresponding to the bandgap energy of Al0.73Ga0.27As) or even <500 nm (energy greater than bandgap of any alloy of the InAlGaAsP system) may be advantageous, depending on the materials and structure of interest.

However, the wavelength should be optimized within other constraints. As an example, for GaAs device, if the wavelength becomes too short, information about layers such as the emitter cap of a Heterojunction Bipolar Transistor (HBT) or the n+ cap of a High Electron Mobility Transistor (HEMT) may be difficult to extract due to optical absorption. Likewise, if the wavelength becomes too long, less information may be available from layers such as HBT InGaP emitter or AlGaAs Schottky layers. Optimization of multiple wavelengths is important such that data from all layers of interest can be captured with maximum precision.

The teachings of Rehder, E. M., et al., “In Situ Monitoring of HBT Epi Wafer Production: The Continuing Push Towards Perfect Quality and Yields,” CS MANTECH Conference, May 18-21, 2009, Tampa, Fla., USA, are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method of monitoring deposition of thin films onto a substrate, comprising the steps of:
a) in-situ monitoring to generate reflectance oscillation data during growth of a thin film;
b) curve fitting the reflectance oscillation data to thereby extract information on the thickness, growth rate, composition, or doping of the thin film; and
c) monitoring the thin film, which comprises at least a portion of a BiHEMT structure.

2. The method of claim 1 whereby the thin films consist of at least one III-V semiconducting material.

3. The method of claim 1 whereby the thin films consist of at least one member of the group consisting of GaAs, AlGaAs, InGaAs, InGaP, InGaAsP, and InGaAsN.

4. The method of claim 1 where multiple wavelengths of incident light are used for in-situ monitoring.

5. The method of claim 4 where at least one of the wavelengths used for in-situ monitoring is <600 nm.

6. The method of claim 4 where at least one of the wavelengths used for in-situ monitoring is <550 nm.

7. The method of claim 4 where at least one of the wavelengths used for in-situ monitoring is <500 nm.

8. The method of claim 1 where a partial reflectance oscillation is used for curve fitting.

9. The method of claim 1 where no reflectance minimum or maximum is used for curve fitting.

10. The method of claim 1 where the slope of reflectance between extrema is used for curve fitting.

11. The method of claim 1 where the reflectance before and after a layer are used to monitor film thickness.

12. The method of claim 1 where the slope of an oscillation is used for curve fitting.

13. A method of calibrating thickness uniformity, comprising the steps of:
a) in-situ monitoring to generate reflectance oscillation data during growth of a thin film;
b) curve fitting the reflectance data to thereby extract information on the thickness, growth rate, composition, or doping of the thin film; and
c) calibrating for thicknesses of multiple layers of a device structure that includes the thin film.

14. The method of claim 13 where the device structure is a BiHEMT.
